(19) United States
(12) Patent Application Publication
(10) Pub. No.: US 2013/0294650 A1
(43) Pub. Date: Nov. 7, 2013

(54) IMAGE GENERATION DEVICE

(71) Applicant: PANASONIC CORPORATION, Osaka (JP)

(72) Inventors: Eiji FUKUMIYA, Osaka (JP); Katsuyuki MORITA, Osaka (JP); Koichi HOTTA, Hyogo (JP)

(21) Appl. No.: 13/936,822

(22) Filed: Jul. 8, 2013

Related U.S. Application Data
(63) Continuation of application No. PCT/JP2012/004451, filed on Jul. 10, 2012.

(30) Foreign Application Priority Data
Feb. 16, 2012 (JP) 2012-031287

(51) Int. Cl. G06T 7/20

(52) U.S. Cl. CPC G06T 7/20
USPC 382/103

(57) ABSTRACT

An image generation device includes: an object information obtaining unit which obtains a location of an object; an image information obtaining unit which obtains images captured from a moving object and locations of the moving object of a time when the respective images are captured; a traveling direction obtaining unit which obtains directions of travel of the moving object of the time when the respective images are captured; and an image cropping unit which calculates a direction of view covering both a direction from a location of the moving object toward the location of the object and one of a direction of travel of the moving object and an opposite direction to the direction of travel, and crops an image, which is one of the images, into a cropped image, which is a portion of an angle of view of the image, based on the calculated direction of view.

### CROSS REFERENCE TO RELATED APPLICATIONS

This is a continuation application of PCT International Application No. PCT/JP2012/004451 filed on Jul. 10, 2012, designating the United States of America, which is based on and claims priority of Japanese Patent Application No. 2012-031287 filed on Feb. 16, 2012. The entire disclosures of the above-identified applications, including the specifications, drawings and claims are incorporated herein by reference in their entirety.

### FIELD

One or more exemplary embodiments disclosed herein relate generally to an image generation device which crops images generated by capturing a forward view or a backward view from a moving object in advance.

### BACKGROUND

Patent literature (PTL) 1 discloses a railroad vehicle including an image information distribution display system which can display a variety of information at the right time by superimposing it on captured images of a forward view when (i) the forward view is captured in real time by an imaging device while the railroad vehicle is moving and (ii) the images of the forward view are displayed on passenger monitors equipped to each of cars.

### CITATION LIST

### Patent Literature

[PTL1] Japanese Unexamined Patent Application Publication No. 2005-14784

### SUMMARY

### Technical Problem

However, in the technique disclosed in PTL 1, while it is possible to display images of an object such as a building included in a forward view, it is sometimes hard to display the images in an appropriate manner that allows a viewer to easily catch the object.

In view of this, one non-limiting and exemplary embodiment was conceived in order to solve such a problem, and provides an image generation device which can display images obtained by capturing the forward or backward view from the moving object, in an appropriate manner that allows a viewer to easily recognize the object.

### Solution to Problem

In order to achieve one non-limiting and exemplary embodiment, an image generation device according to an aspect of the present disclosure includes: an object information obtaining unit which obtains a location of an object; an image information obtaining unit which obtains images captured from a moving object and locations of the moving object of a time when the respective images are captured; a traveling direction obtaining unit which obtains directions of travel of the moving object of the time when the respective images are captured; and an image cropping unit which (i) calculates a direction of view covering both a direction from a location of the moving object toward the location of the object and one of a direction of travel of the moving object and an opposite direction to the direction of travel, and (ii) crops an image into a cropped image based on the calculated direction of view, the image being one of the images, the cropped image being a portion of an angle of view of the image, the location of the moving object being of a time when the image is captured, the direction of travel of the moving object being of the time when the image is captured.

It should be noted that these general or specific aspects may be implemented by a method, an integrated circuit, a computer program, a recording medium such as a computer-readable CD-ROM, or any combination of them.

### Advantageous Effects

An image generation device and an image generation method according to the present disclosure can display images obtained by capturing a forward or backward view from a moving object, in an appropriate manner that allows a viewer to easily recognize an object.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 illustrates a block diagram showing a configuration of an image generation device according to an embodiment of the present disclosure.

FIG. 2 illustrates a screen of an object information obtaining unit.

FIG. 3 illustrates object information in which an object is associated with object relevant information.

FIG. 4 illustrates a table in which an object is associated with an input comment.

FIG. 5 illustrates a flowchart showing an image generation process.

FIG. 6 illustrates a flowchart showing a direction-of-view determination process.

FIG. 7 is a diagram for illustrating a direction of travel of a car and a direction of view.

FIG. 8A is a diagram for illustrating a direction-of-travel angle.

FIG. 8B is a diagram for illustrating an object-vector angle.

FIG. 9 illustrates locations of a moving car and directions of view at the respective locations in a case where the image generation process is not performed.

FIG. 10A illustrates an image captured when the moving car is located at a point P1 in FIG. 9.

FIG. 10B illustrates an image captured when the moving car is located at a point P2 in FIG. 9.

FIG. 10C illustrates an image captured when the moving car is located at a point P3 in FIG. 9.

FIG. 10D illustrates an image captured when the moving car is located at a point P4 in FIG. 9.

FIG. 11 illustrates locations of the moving car and directions of view at the respective locations in a case where the image generation process is performed.

FIG. 12A illustrates an image captured when the moving car is located at a point P1 in FIG. 11.

FIG. 12B illustrates an image captured when the moving car is located at a point P2 in FIG. 11.

FIG. 12C illustrates an image captured when the moving car is located at a point P3 in FIG. 11.

FIG. 12D illustrates an image captured when the moving car is located at a point P4 in FIG. 11.

FIG. 13 is a diagram for illustrating a calculation method of a location of a set of objects.

FIG. 14 is a diagram for illustrating a change in a cropped angle of view. (a) in FIG. 14 illustrates a state in which the cropped angle of view has not yet been widened when distances between respective objects and the moving car are the same, and (b) in FIG. 14 illustrates a state in which the cropped angle of view has been widened when the distances between respective objects and the moving car are the same.

FIG. 15 is a diagram for illustrating the direction-of-view determination process for images of a backward view.

FIG. 16 is a diagram for illustrating the direction-of-view determination process for a curved path of travel.

### DESCRIPTION OF EMBODIMENTS

(Underlying Knowledge Forming Basis of the Present Disclosure)

In relation to the image information distribution display system disclosed in the Background section, the inventers have found the following problem.

The technique disclosed in PTL1 has a problem that an object such as a building is hard to be continuously displayed during a certain amount of time in a case where the object included in images of a forward view is located at a position far away from a direction of travel of a train.

In order to solve such a problem, an image generation device according to an aspect of the disclosure includes: an object information obtaining unit which obtains a location of an object; an image information obtaining unit which obtains images captured from a moving object and locations of the moving object of a time when the respective images are captured; a traveling direction obtaining unit which obtains directions of travel of the moving object of the time when the respective images are captured; and an image cropping unit which (i) calculates a direction of view covering both a direction from a location of the moving object toward the location of the object and one of a direction of travel of the moving object and an opposite direction to the direction of travel, and (ii) crops an image into a cropped image based on the calculated direction of view, the image being one of the images, the cropped image being a portion of an angle of view of the image, the location of the moving object being of a time when the image is captured, the direction of travel of the moving object being of the time when the image is captured.

With this, even when the object is located at the position far away from the direction of travel of the moving object, the object can continuously appear during a certain amount of time in images of a forward or backward view captured from the moving object.

By the way, recently, SNS (social networking service) spreads rapidly among people. If a comment or photo about a building near the railroad tracks or the like which has been posted through such a service can be displayed in association with the building in the images of the forward view, a new dimension is expected to be brought to the SNS.

In order to meet such needs, the image generation device may further include an image generation unit which generates images in each of which information on the object is associated with the object in the cropped image, in which the object information obtaining unit further obtains the information on the object.

With this, for example, information on an object posted through the SNS, such as a comment or photo about the object near a path of travel of the moving object, can be displayed in association with the object in the images of the forward view. Furthermore, for example, when images in which the information on the object such as the comment or photo is superimposed at the location of the object are generated, the superimposed information on the object can be continuously displayed during a certain amount of time in a similar manner to the object.

In addition, for example, the image cropping unit may determine the direction of view based on a weighting factor given to the direction from the location of the moving object toward the location of the object and a weighting factor given to one of the direction of travel and the opposite direction.

In addition, for example, the image cropping unit may crop the image into the cropped image so that one of (i) the direction from the location of the moving object toward the location of the object and (ii) one of the direction of travel and the opposite direction is positioned within a predetermined range of an angle between directions corresponding to both ends of the cropped image.

In addition, for example, the traveling direction obtaining unit may derive and obtain, from two or more locations where the respective images are captured, the directions of travel of the moving object each related to a corresponding one of the locations where the respective images are captured.

In addition, for example, the image cropping unit may crop the image into the cropped image having a wider angle of view for a higher weighting factor given to the object.

In addition, for example, when a plurality of the objects exist, the image cropping unit may determine the direction of view based on weighting factors given to the respective objects.

In addition, for example, when a plurality of the objects exist, the image cropping unit may crop the image into the cropped image having a widened angle of view that allows the objects to be included in the cropped image.

In addition, for example, the image cropping unit may crop, into the cropped image, an image of the images which is at least during a time period when the object is included, and covers both the direction from the location of the moving object toward the location of the object and one of the direction of travel and the opposite direction.

It should be noted that these general or specific aspects may be implemented by a method, an integrated circuit, a computer program, a recording medium such as a computer-readable CD-ROM, or any combination of them.

Hereinafter, an image generation device and an image generation method according to the present disclosure are described in detail with reference to the accompanying drawings. In the description, a car is used as a moving object.

It should be noted that each of the embodiments described below is a specific example of the present disclosure. The numerical values, shapes, constituent elements, steps, the processing order of the steps etc. shown in the following embodiments are mere examples, and thus do not limit the present disclosure. Thus, among the constituent elements in the following embodiments, constituent elements not recited in any of the independent claims indicating the most generic concept of the present disclosure are described as preferable constituent elements.

### Embodiment 1

(1. Configuration)

An image generation device 100 according to an embodiment 1 is a device which performs an image processing on images of a view captured from a moving object. In the embodiment 1, the images are of a time when a forward view from a car is captured as a video.

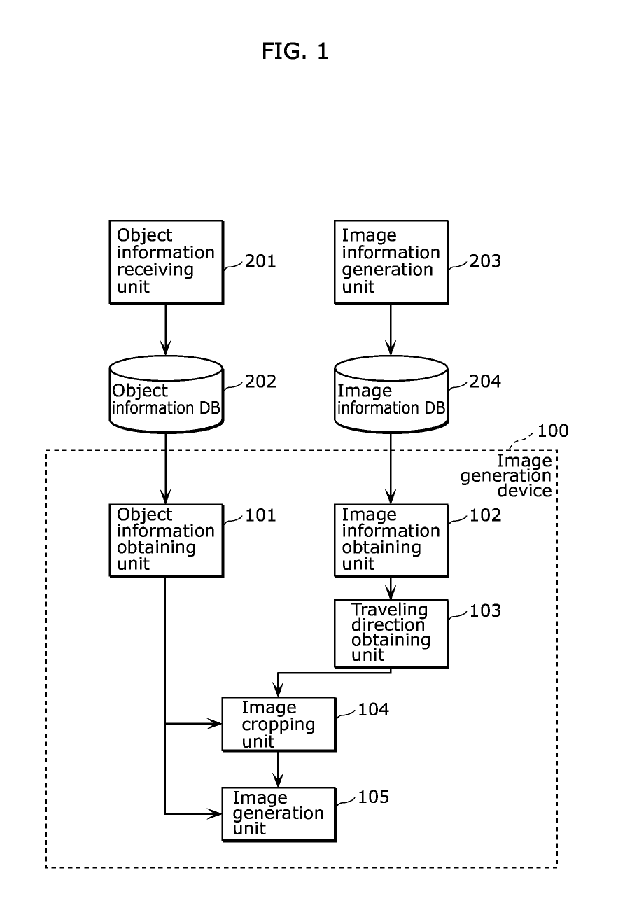

FIG. 1 illustrates a block diagram showing a configuration of the image generation device according to the embodiment 1 of the present disclosure.

The image generation device 100 includes an object information obtaining unit 101, an image information obtaining unit 102, a traveling direction obtaining unit 103, an image cropping unit 104, and an image generation unit 105.

The object information obtaining unit 101 obtains a location of an object. The object information obtaining unit 101 also obtains information on the object (hereinafter, referred to as “object relevant information”). More specifically, the object information obtaining unit 101 obtains object information in which an object such as a point designated on a map or a location of a building at the point is paired with the object relevant information such as a comment about the object.

The object information obtaining unit 101 is communicatively connected to an object information DB 202. The object information DB 202 stores the object information. The object information DB 202 is communicatively connected to an object information receiving unit 201. The object information receiving unit 201 is a PC or portable device such as a tablet computer for example, which sends the object information inputted by a user to the object information DB, and causes the sent object information to be stored in the object information DB.

The image information obtaining unit 102 obtains image information in which a location of the car is related to an image that is captured from the car at the location at a predetermined angle of view. In short, the image information obtaining unit 102 obtains images captured from a moving object and locations of the moving object of a time when the respective images are captured. Here, the images captured from a moving object mean images captured while the object is moving. The image information obtaining unit obtains images captured from the moving object and locations of the moving object of the time when the respective images are captured, as the image information in which each of the images is related to a corresponding one of the locations. It should be noted that the term “moving” includes a case where the car is stopping at a red light or a case where a train is stopping at a station for example. More specifically, even if a speed of travel of the moving object is “0”, a case where the moving object is between a departure point and a destination may be regarded as “moving”. A time period when the images are taken may also be regarded as “moving”. In other words, the term “moving” does not exclude a case where the moving object is stopping.

The image information obtaining unit 102 is communicatively connected to the object information DB 204. The image information DB 204 stores the image information. The image information DB 204 is communicatively connected to an image information generation unit 203. The image information generation unit 203 measures locations of the car during car travel through a technique such as Global Positioning System (GPS), and obtains the locations of the car and the images captured at the respective locations by taking a video at a predetermined angle of view (360 degrees in the embodiment 1) from the car at the respective locations using a device for taking a video. The image information generation unit 203 generates the image information by relating each of the locations of the car to a corresponding one of the images.

The traveling direction obtaining unit 103 obtains directions of travel of the moving object each related to a corresponding one of the locations of the car of the time when the respective images are captured. More specifically, the traveling direction obtaining unit 103 derives and obtains, from two or more locations where the respective images are captured, the directions of travel of the moving object each related to a corresponding one of the locations where the respective images are captured.

The image cropping unit 104 calculates, based on the location of the object and the direction of travel, a direction of view indicating a direction of a field of view to be cropped so as to include, in a cropped image, the object and the view from the car toward the direction of travel. For each of image frames of a panoramic video, the image frame (an image) is cropped, based on the calculated result, into a presentation frame which is a cropped image that is a predetermined portion of an angle of view of the image frame. In other words, the image cropping unit 104 crops the image into the cropped image, which is a portion of an angle of view of one of the images, so as to cover both a direction from the location of the moving object toward the location of the object and a direction of travel of the moving object (or an opposite direction to the direction of travel). It should be noted that the image cropping unit 104 crops the image into the cropped image for each of all or some of the images. The direction from the location of the moving object toward the location of the object is derived from the location of the object obtained by the object information obtaining unit 101 and the location of the moving object of a time when the image is captured. The direction of travel is the direction of travel of the moving object of the time when the image is captured, which is obtained by the traveling direction obtaining unit 103. In other words, based on the location of the object obtained by the object information obtaining unit 101, the location of the moving object of the time when the image is captured, and the direction of travel of the moving object obtained by the traveling direction obtaining unit 103, the image cropping unit 104 crops the image into the cropped image which is an portion of the angle of view of the image obtained by the image information obtaining unit 102 so as to cover both the object and the direction of travel (or the opposite direction to the direction of travel) corresponding to the location of the moving object of the time when the image are captured. It should be noted that the portion of the angle of view of the image (hereinafter, referred to as a “cropped angle of view”) is an angle of view smaller than the angle of view of the image and a predetermined angle of view. Then, the image cropping unit 104 relates the presentation frame to the location of the object and provides the resulting presentation frame. The image cropping unit 104 also determines the direction of view which is to be positioned at a center of the cropped image, based on a weighting factor given to the direction from the location of the moving object toward the location of the object and a weighting factor given to the direction of travel of the moving object (or the opposite direction to the direction of travel). The image cropping unit 104 also crops the image into the cropped image so that one of (i) the direction from the location of the moving object toward the location of the object and (ii) the direction of travel (or the opposite direction to the direction of travel) is positioned within a predetermined range of an angle between directions corresponding to both ends of the cropped image.

The image generation unit 105 superimposes a comment about the object on the presentation frame and presents the presentation frame with the comment to a user. In other words, the image generation unit 105 generates images in each of which the object relevant information is associated with the object in the presentation frame which is the cropped image. In the embodiment 1, the image generation unit 105 superimposes a larger comment about the object on the presentation frame for the object closer to the car, and presents the presentation frame with the comment to a user. It should be noted that the image generation unit 105 may generate images in each of which the comment about the object is shown on the outside of the presentation frame, instead of images in each of which the comment about the object is superimposed on the presentation frame.

(2. Operations)

Hereinafter, illustrative embodiments are described in detail.

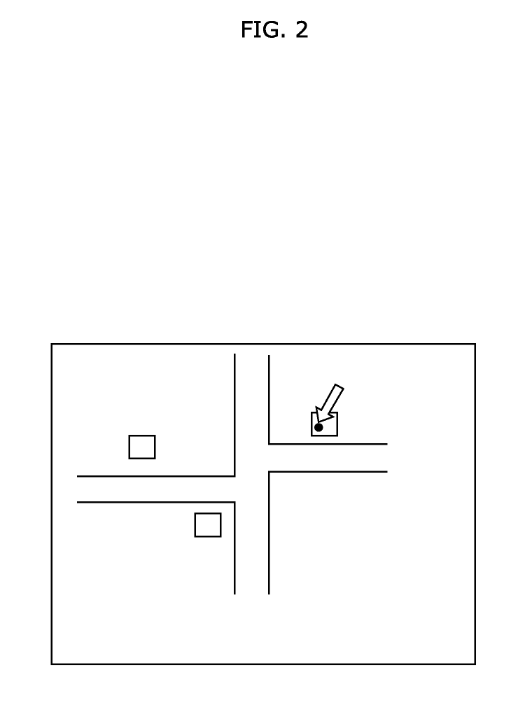

FIG. 2 illustrates an exemplary screen of the object information receiving unit 201.

A user can designate a location on a map through a device having a GUI such as a portable device or PC which is used as the object information receiving unit 201, as shown in FIG. 2, to input a comment as the object relevant information for the designated location. More specifically, the user designates a location of an object by pointing a location on the map displayed on the screen (see FIG. 2) through a pointing device such as a touch panel or computer mouse. Then, for example, an input space for inputting a comment for the location of the object designated on the map appears on the object information receiving unit 201, and it receives the comment about the object from the user.

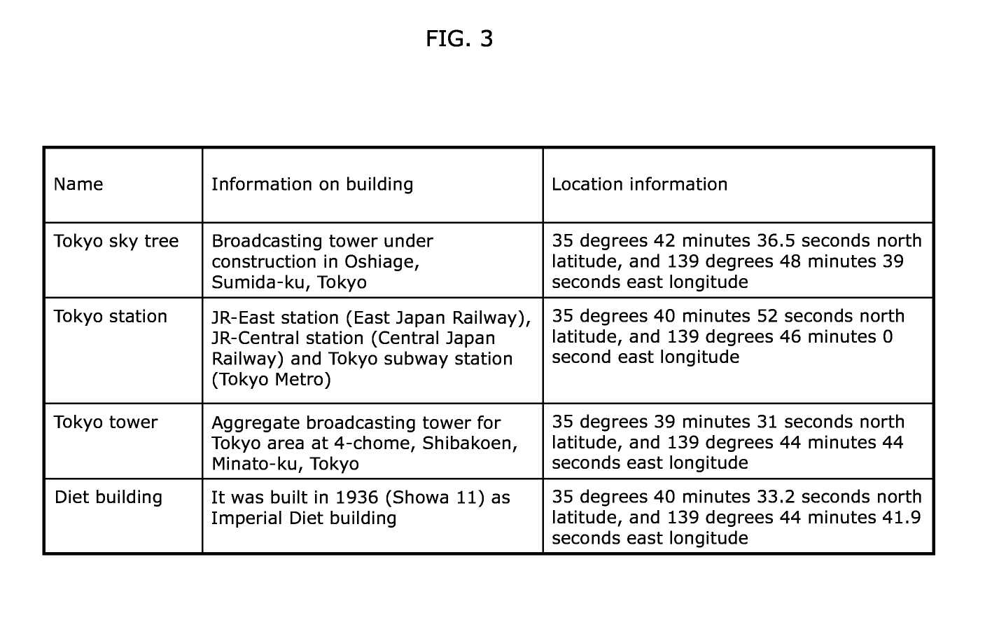

It should be noted that the reception of the object relevant information is not limited to the designation of the location on the map as described above. The object relevant information may be received by selecting, as an object, a building from among items of object information list as shown in FIG. 3 for example. In FIG. 3, buildings are listed as an example of the object, but a place such as a mountain, a lake, or a river is possible. In this case, for example, the input space for inputting a comment for the location of the object designated on the list appears on the object information receiving unit 201, and it receives the comment about the object from the user. In other words, the object information is information in which a name of building regarded as the object is associated with the object relevant information and location information of the building. In this case, a position coordinate in the list may be used as the location of the object. Alternatively, a centroid position of the building area may be used as the location of the object. It should be noted that FIG. 3 illustrates the object information in which the object is associated with the object relevant information.

Furthermore, it is possible to select only a building from the list and receive no comment. In this case, the image generation unit 105 may present, as the object relevant information, the name of the building or the information on the building, and may display a mark, a symbol, or the like instead of the comment. In other words, the object relevant information includes a comment, information on a building, a name of building, a mark, a symbol, or the like. What to display as the object relevant information may be determined in advance by default, or selected by a user. In this case, the object information DB 202 stores whether the object relevant information is determined in advance or selected.

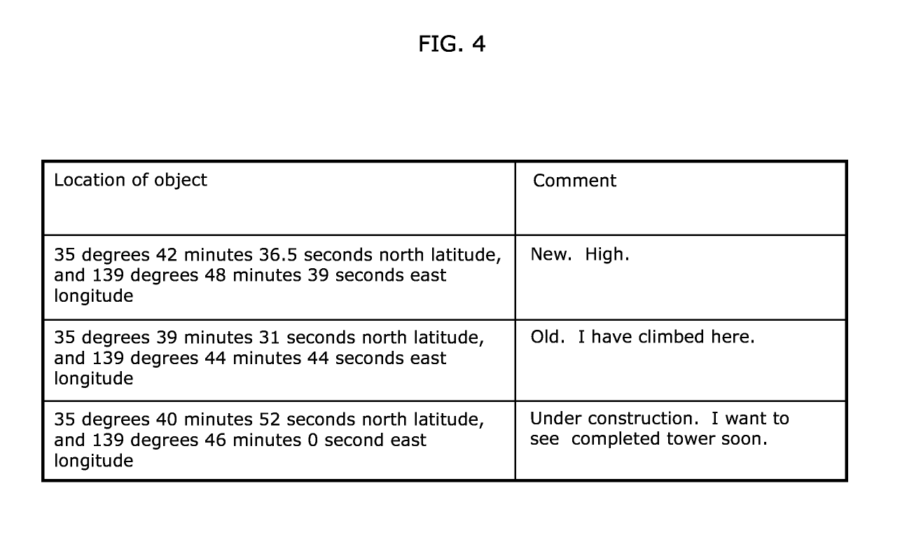

FIG. 4 illustrates a table in which the object is associated with an input comment.

When the object information receiving unit 201 receives the input comment and the location of the object designated on the map as described above, the object information DB 202 uses the table shown in FIG. 4 to store the object. It should be noted that when the object information receiving unit 201 receives different types of information other than the comment and the location of the object, the table shown in FIG. 4 may further include other items for the respective types of information. It should be noted that, in the following description, the mark, the symbol, or the like is regarded as the comment.

The image information generation unit 203 includes a car-mounted device for taking a panoramic video, and a device for measuring a current location through a technique such as GPS. The image information generation unit 203 moves while measuring the current location, and generates, as image information, the panoramic video with position coordinates in which each of image frames is paired with a corresponding one of locations where the respective image frames are captured.

The image information DB 204 stores the panoramic video with position coordinates in which each of the image frames generated by the image information generation unit 203 is paired with a corresponding one of the locations where the respective image frames are captured. The image information DB 204 need not store the image frames and the locations in a specified form only if they are stored in pairs.

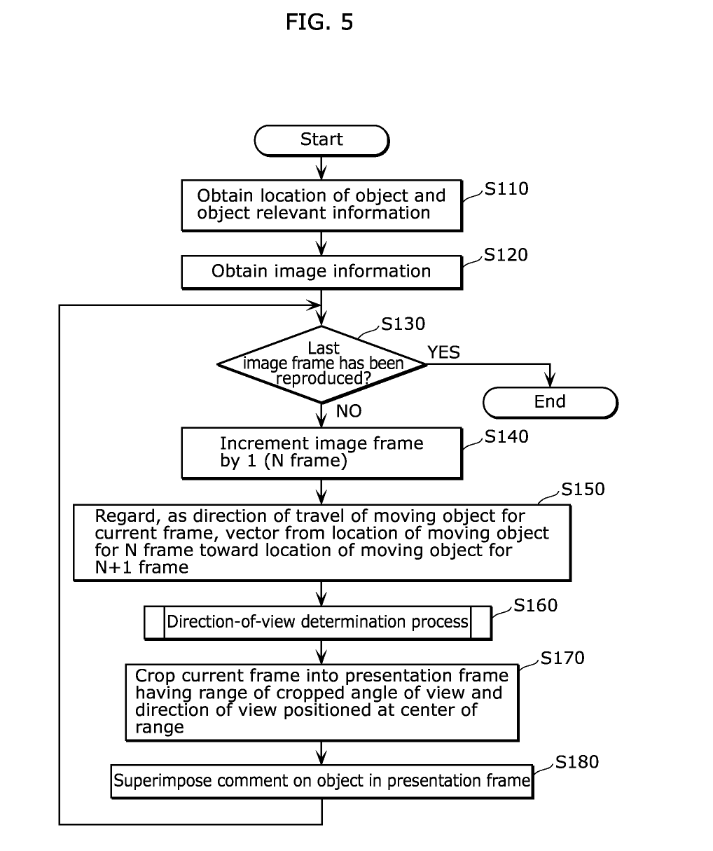

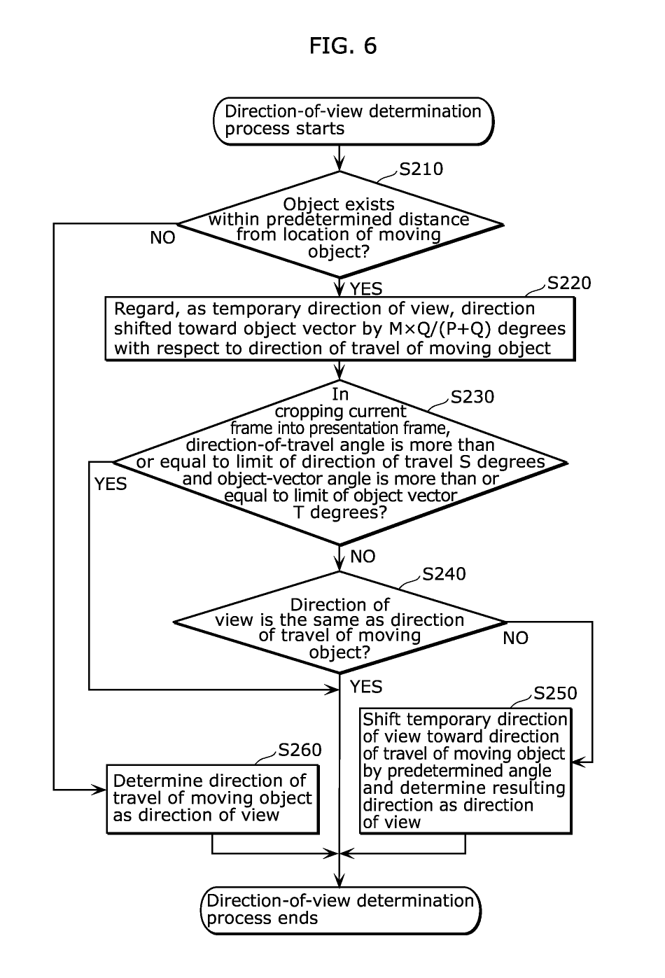

Hereinafter, an image generation process in image reproduction is described with reference to FIG. 5 and FIG. 6. FIG. 5 is a flowchart showing the image generation process. FIG. 6 is a flowchart showing a direction-of-view determination process.

The object information obtaining unit 101 obtains the location of the object and the object relevant information from the object information DB 202 (S110). The image information obtaining unit 102 obtains the image information in which the location of the moving car is related to the image captured from the car at the location at a predetermined angle of view (S120).

It is determined whether or not the last image frame of the images has been reproduced based on the obtained image information (S130). In this step, if it is determined that the last image frame of the images has been reproduced (S130: Yes), then the image generation process is terminated. If it is determined that the last image frame of the images has not been reproduced (S130: No), then the process proceeds to the next step S140. It should be noted that the determining in Step S130 is not limited to whether the image reproduction is actually being performed. It is possible to determine whether or not internal data necessary to the image reproduction of the last image frame has been generated.

Next, the image frame is incremented by 1 (S140). It should be noted that an image frame preceding the incremented image frame is referred to as an N frame which is the N-th image frame. In this step, a current image frame in the image generation process is determined. When there is no processed image frame, the first image frame is regarded as the current image frame.

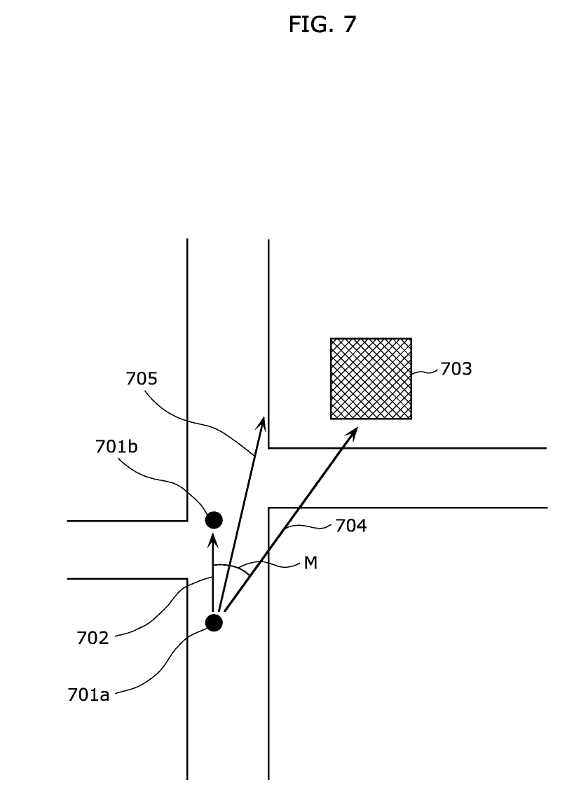

In the image frame determined in Step S140, a vector from a location of the car 701a for the N frame toward a location of the car 701b for an N+1 frame which is a frame following the N frame, as shown in FIG. 7, is regarded as the direction of travel of the car 702 (S150). Here, FIG. 7 is a diagram for illustrating the direction of travel of the car 702 and the direction of view 705. In this manner, in Step S150, the traveling direction obtaining unit 103 derives, from two or more locations where the respective images are captured, the direction of travel of the moving object 702 corresponding to the location where the N frame is captured. In other words, with respect to the location where the N frame is captured (the location of the car for the N frame) 701a, a direction from the location where the N frame is captured 701a toward the location where the N+1 frame is captured (the location of the car for the N+1 frame) 701b is derived as the direction of travel 702 corresponding to the location where the N frame is captured 701a.

It should be noted that the direction of travel need not to be derived from two or more locations where the respective images are captured. For example, it is possible to obtain traveling path information indicating a path of travel of the car in advance and derive the direction of travel 702 from the path of travel indicated by the traveling path information and the location where the N frame is captured. In other words, in this case, since the location where the N frame is captured is on the path of travel, a direction of the tangent to the path of travel at the location where the N frame is captured is derived as the direction of travel 702 corresponding to the location where the N frame is captured.

Alternatively, the direction of travel 702 may be derived from direction change information on changing points of the direction of travel at constant time intervals each related to a corresponding one of the image frames. In this case, for example, when (i) information that the car turned 90 degrees to the right is stored for an N+M frame as the direction change information, and (ii) the car had traveled to north for frames preceding the N+M frame, the direction of travel of the car is east for frames following the N+M frame. In addition, in this case, preferably, the direction of travel should be gradually changed from north to east for a predetermined range of frames preceding and following the N+M frame.

The directions of travel 702 may be related to the respective image frames in advance. More specifically, when the images are captured, using a sensor for detecting a direction such as a gyro sensor, detection values of the sensor are stored to be related to the respective captured image frames, and each of the directions of travel may be obtained from a corresponding direction related to the image frame.

The image cropping unit 104 determines the direction of view 705 based on the direction of travel 702 and an object vector 704 drawn from the location of the car 701a toward the location of the object 703 (S160). Referring to FIG. 6, this process will be described in detail below.

The image cropping unit 104 crops an image frame into a presentation frame which is a cropped image having a range of the cropped angle of view and the direction of view determined in Step S160 that is positioned at the center of the range (S170).

The image generation unit 105 associates information on an object with the object in the cropped image by generating images in each of which the information on the object (a comment) is superimposed at the location of the object 703 in the presentation frame generated by the image cropping unit 104 (S180). In other words, the image generation unit 105 superimposes the object relevant information of the object (the comment) at the location of the object in the presentation frame, and generates images to be presented to a user. When Step S180 is terminated, the process returns to Step S130.

Next, referring to FIG. 6, the direction-of-view 705 determination process of the image cropping unit 104 is described in detail.

It is assumed that each of the image frames of the panoramic video is cropped into the presentation frame having a predetermined constant field of view and the direction of view is equal to the direction of travel of the car. When a distance between the object and the car is less than or equal to a predetermined distance, the direction of view is determined in the following manner.

First, the image cropping unit 104 determines whether or not the object exists within the predetermined distance from the location of the car 701a (See FIG. 7) (S210). In this step, if it is determined that the object exists within the predetermined distance from the location of the car 701a (S210: Yes), then the process proceeds to Step S220.

The image cropping unit 104 calculates, from the location of the car 701a, the direction of travel of the car 702, and the location of the object 703, an angle M between the direction of travel of the car 702 and the object vector 704 which is a direction from the location of the car 701a toward the location of the object 703. Then, the image cropping unit 104 determines the direction of view based on a predetermined weighting factor of the direction of travel 702 and a predetermined weighting factor of the object vector 704. For example, when the weighting factor of the direction of travel 702 and the weighting factor of the object vector 704 are “P:Q”, respectively, the image cropping unit 104 regards, as a temporary direction of view, a direction shifted toward the object vector 704 by M×Q/(P+Q) degrees with respect to the direction of travel of the car 702 (S220).

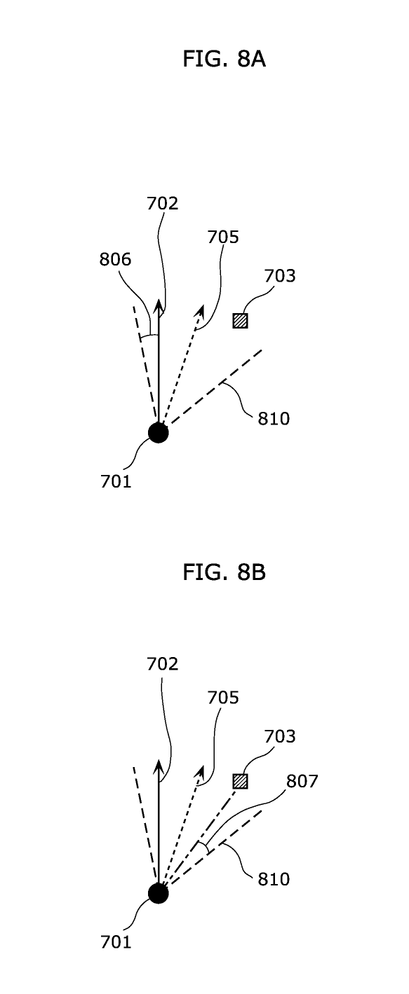

When cropping each of the image frames of the panoramic video into the presentation frame having the range of the cropped angle of view and the temporary direction of view determined in Step S220 that is positioned at the center of the range, the image cropping unit 104 determines whether or not (i) a direction-of-travel angle 806 between the direction of travel 702 and one of the right and left ends of the angle of view of the presentation frame exceeds a limit of the direction of travel S degrees and (ii) an object-vector angle 807 between the object vector 704 and the other of the right and left ends of the angle of view of the presentation frame exceeds a limit of the object vector T degrees (S230, See FIG. 8A and FIG. 8B). It should be noted that the direction-of-travel angle 806 to be determined in this step is an angle between the direction of travel 702 that is within a range of the angle of view of the presentation frame and the left or right end of the angle of view of the presentation frame. Similar to this, the object-vector angle 807 is an angle between the object vector 704 that is within a range of the angle of view of the presentation frame and the left or right end of the angle of view of the presentation frame. At this step, if it is determined that the direction-of-travel angle 806 is more than or equal to the limit of the direction of travel S degrees and the object-vector angle 807 is more than or equal to the limit of the object vector T degrees (S230: Yes), then the image cropping unit 014 determines the temporary direction of view as the direction of view 705, and the direction-of-view 705 determination process is terminated. It should be noted that FIG. 8A is a diagram for illustrating the direction-of-travel angle 806. FIG. 8B is a diagram for illustrating the object-vector angle 807.

The determining in Step S230 can prevent the direction-of-travel angle 806 as shown in FIG. 8A from being less than the limit of the direction of travel S degrees with respect to the left end of the presentation frame and also prevent the object-vector angle 807 as shown in FIG. 8B from being less than the limit of the object vector T degrees with respect to the right end of the presentation frame. Such an angle restriction of the direction-of-travel angle 806 can reduce a loss of a realistic sensation for images of a view when the direction of travel of the car 702 is substantially positioned at the end of the presentation frame. Furthermore, such an angle restriction of the object-vector angle 807 can adequately ensure the visibility of the object. It should be noted that the foregoing S degrees and T degrees each may be set to an appropriate value or zero.

If it is not determined that the direction-of-travel angle 806 is more than or equal to the limit of the direction of travel S degrees and the object-vector angle 807 is more than or equal to the limit of the object vector T degrees (S230: No), then the image cropping unit 104 determines whether or not the temporary direction of view determined in Step S220 is the same as the direction of travel of the car 702 (S240).

If it is determined that the temporary direction of view is the same as the direction of travel of the car 702 (S240: Yes), then the image cropping unit 104 determines the temporary direction of view as the direction of view 705, and the direction-of-view 705 determination process is terminated.

If it is not determined that the temporary direction of view is the same as the direction of travel of the car 702 (S240: No), then the image cropping unit 104 shifts the temporary direction of view toward the direction of travel 702 by a predetermined angle and determines the resulting temporary direction of view as the direction of view 705 (S250), and the direction-of-view 705 determination process is terminated.

In Step S210, if it is not determined that the object exists within the predetermined distance from the location of the car 701a (S210: No), then the image cropping unit 104 determines the direction of travel of the car 702 as the direction of view 705, and the direction-of-view 705 determination process is terminated.

When the object vector 704 is not included in the presentation frame, the image cropping unit 104 changes the direction of view 705 until it becomes the same as the direction of travel of the car 702. It is because the direction of view 705 is determined as described above. In the changing, in order to perform Step S250, the image cropping unit 104 gradually changes, in the image, the direction of view 705 to be the same as the direction of travel of the car 702. In Step S250, it should be noted that an angle of the direction of view 705 for a frame is changed, but not limited to this. The direction of view 705 may be gradually changed to be the same as the direction of travel of the car 702 while plural frames following the frame (for example, two or three frames) are handled. In other words, for example, for each of the frames, the image cropping unit 104 shifts the direction of view 705 by a predetermined angle until the direction of view becomes the same as the direction of travel of the car 702. This prevents the images from being hard to see for a user due to a sudden change in the direction of view.

When an image frame of the panoramic video is cropped into a presentation frame, the location of the object in the presentation frame can be identified from an angle between the direction of travel of the car 702 and the object vector 704.

(Specific Examples)

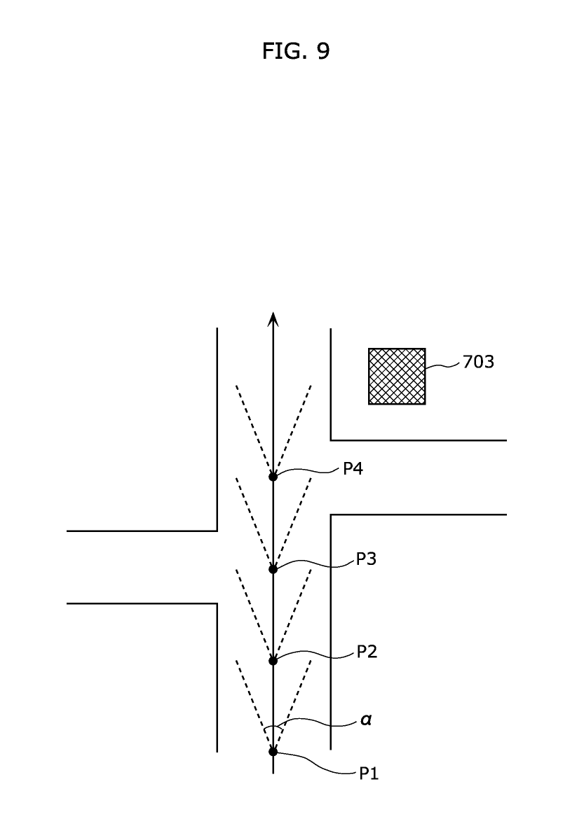

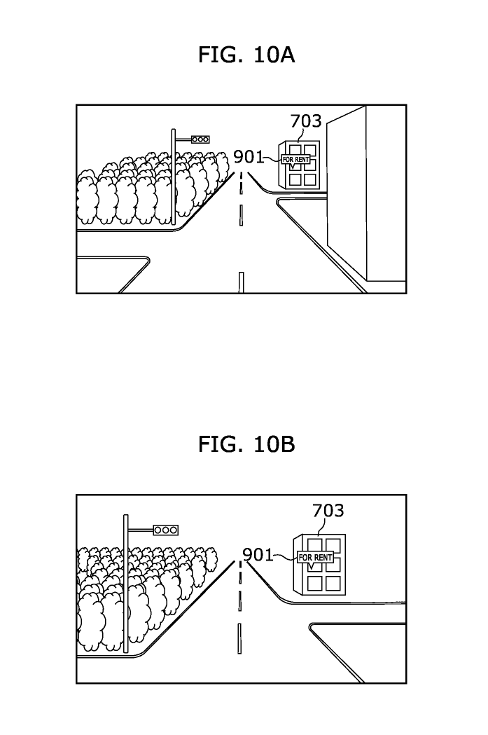

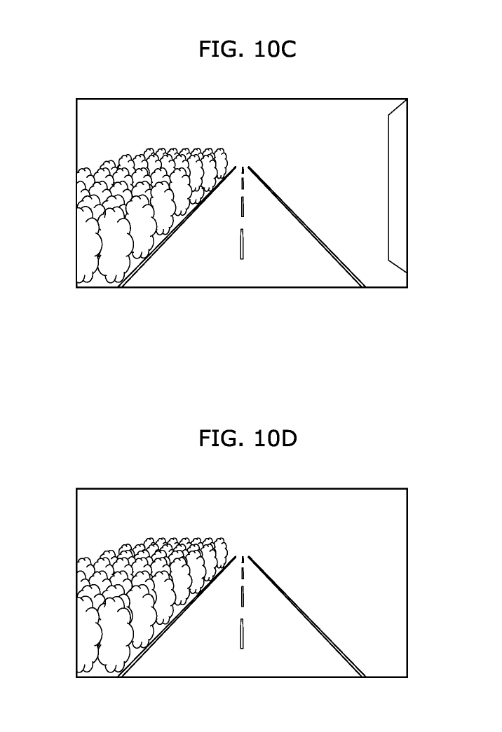

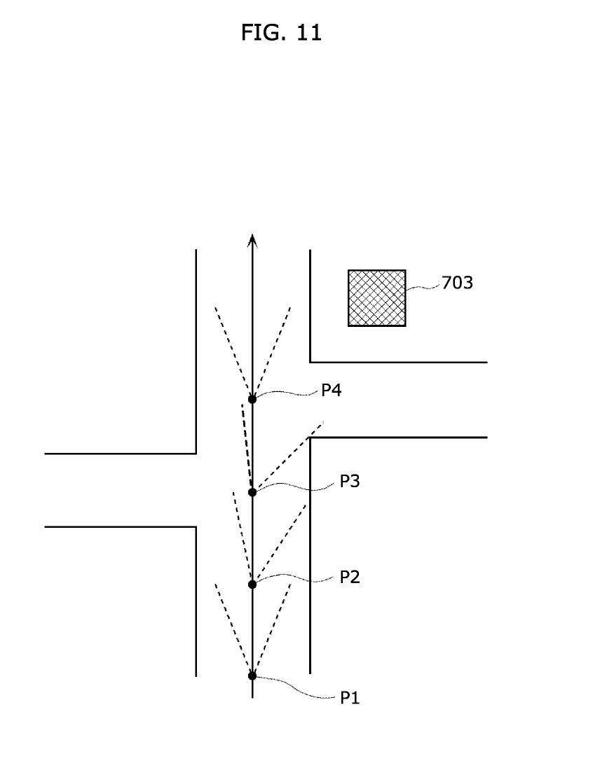

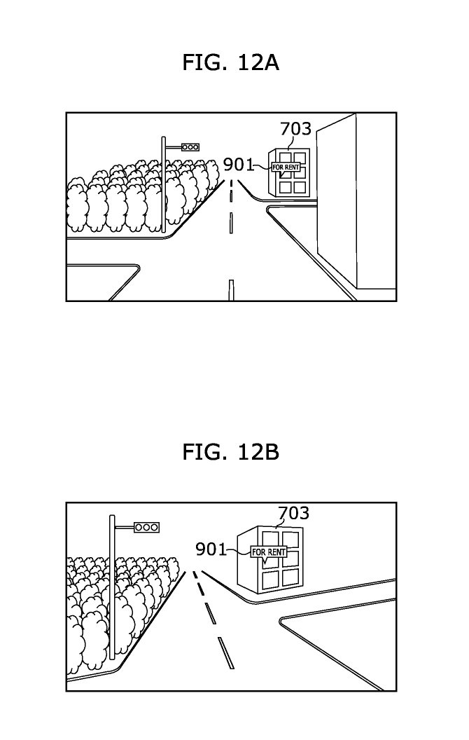

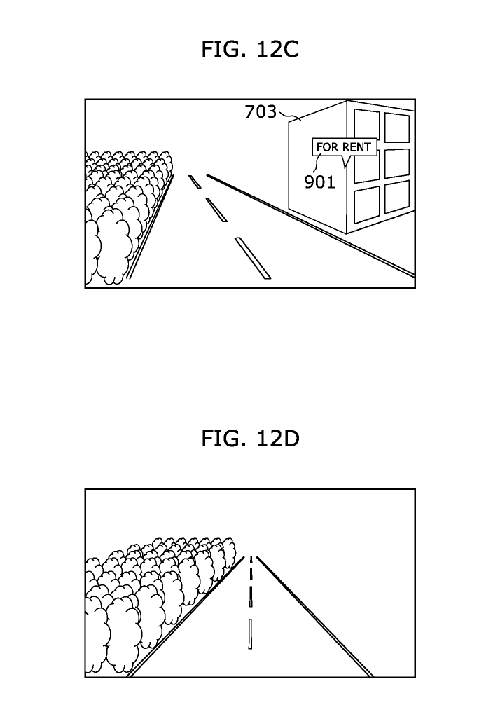

FIG. 9 illustrates locations of a moving car and directions of view at the respective locations in a case where the image generation process is not performed. FIG. 10A illustrates an image captured when the moving car is located at a point P1 in FIG. 9. FIG. 10B illustrates an image captured when the moving car is located at a point P2 in FIG. 9. FIG. 10C illustrates an image captured when the moving car is located at a point P3 in FIG. 9. FIG. 10D illustrates an image captured when the moving car is located at a point P4 in FIG. 9. FIG. 11 illustrates locations of the moving car and directions of view at the respective locations in a case where the image generation process is performed. FIG. 12A illustrates an image captured when the moving car is located at a point P1 in FIG. 11. FIG. 12B illustrates an image captured when the moving car is located at a point P2 in FIG. 11. FIG. 12C illustrates an image captured when the moving car is located at a point P3 in FIG. 11. FIG. 12D illustrates an image captured when the moving car is located at a point P4 in FIG. 11.

As shown in FIG. 9, when the image generation process is not performed, the direction of view is the direction of travel of the car. In view of this, even when a comment “FOR RENT” is associated with the location of the object 703 for example, although a viewer can recognize the comment “FOR RENT” at the points P1 and P2 in FIG. 9, as shown in FIG. 10A and FIG. 10B, the viewer can not recognize an object image at the location of the object 703 or the comment “FOR RENT” because the location of the object 703 is almost outside the angle of view of an image captured at the point P3 in FIG. 9, as shown in FIG. 10C. Thus, the viewer can not recognize, at the point P3, the object image at the location of the object 703 or the comment “FOR RENT” because images are displayed in which an angle of view a at the point P1 is kept and the direction of view is constant.

On the other hand, when the image generation process is performed as shown in FIG. 11, an image of the panoramic video is cropped so as to shift the direction of view toward the object. Accordingly, similar to the foregoing, when a comment “FOR RENT” is associated with the location of the object 703 for example, the viewer can recognize the object image at the location of the object 703 or the comment “FOR RENT” at the points P1, P2, and P3 in FIG. 11, as shown in FIG. 12A, FIG. 12B, and FIG. 12C, respectively. In other words, although the viewer can not recognize the object image at the location of the object 703 or the comment “FOR RENT” when the image generation process is not performed, the viewer can recognize, at the point P3, the object image at the location of the object 703 or the comment “FOR RENT” by performing the image generation process. Thus, the image generation process allows the viewer to catch the object image at the location of the object 703 or the comment “FOR RENT” for as long a period as possible.

With the image generation device 100 according the embodiment 1, even when the object is located at the position away from the direction of travel of the car, the object image can be displayed during a certain amount of time for images of a forward view captured from the car.

In addition, with the image generation device 100 according the embodiment 1, information on the object such as a comment or photo about the object around a path of travel of the car, which has been posted through the SNS, can be displayed in association with the object in the images of the forward view. Furthermore, for example, when images in which the information on the object such as the comment or photo is superimposed on the object image are generated for example, the information on the object can be displayed during a certain amount of time in a similar manner to the object.

### Embodiment 2

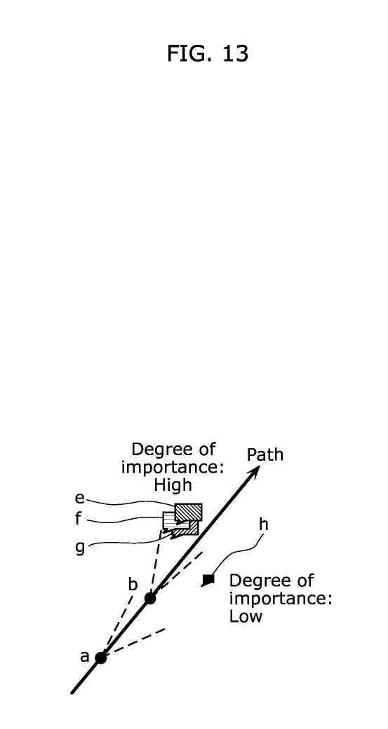

In the embodiment 1, one object exists, but a plurality of objects may exist. In this case, the object information DB 202 stores object information on the objects. In this case, the image cropping unit 104 determines a location of a set of the objects, and uses it instead of the location of the object 703 according to the embodiment 1. This means that, when a plurality of the objects exist, the image cropping unit 104 determines the direction of view which is to be positioned at a center of the cropped image, based on weighting factors given to the respective objects. The image cropping unit 104 calculates the location of the set of the objects by weighting the objects according to a degree of importance of each object and a distance between each object and the car. The degree of importance of the object may be determined based on the number of characters in a comment posted about the location of the object. Alternatively, the degree of importance may be determined according to the density of posted comments when many comments are posted about the same building or there are many comments in the neighborhood even if the buildings are different. For example, as shown in FIG. 13, when different objects are located within a certain range of distance from an object, the degree of importance may be set to a high value. It should be noted that the weighting according to the degree of importance of the object means that the weighting factor of the object is set to a greater value for a higher degree of importance. The weighting according to the distance between the object and the car means that the weighting factor of the object is set to a greater value for the object closer to the car.

FIG. 13 is a diagram for illustrating a calculation method of the location of the set of the objects.

An embodiment 2 is different from the embodiment 1 in only the calculation method of the location of the object, and thus only the calculation method of the location of the object is described. For example, the calculation method of the location of the set of the objects is the following.

The degrees of importance for the objects e, f, g, and h in FIG. 13 are represented as E, F, G, and H, respectively. The distances between the respective objects e, f, g, and h and the car are represented as d1, d2, d3, and d4, respectively.

A weighting factor for the degree of importance of the object and a weighting factor for the distance between the car and the object are represented as V and W, respectively. Accordingly, the weighted position coordinates are calculated by applying weighting factors “V×E+W×d1”, “V×F+W×d2”, “V×G+W×d3”, and “V×H+W×d4” to the position coordinates of the objects e, f, g, and h, respectively, and a centroid position of the weighted position coordinates is determined as the location of the set of the objects.

It should be noted that, preferably, the values V and W should be set to appropriate values so as to include an object in the image even when the degree of importance of the object is low. When the appropriate values are provided and the car is at a point a in FIG. 13, the distance between the car and the object h is shorter than the distance between the car and each of the objects e, f, and g, so that the weighting for the object h is greater than the weighting for the objects e, f, and g. Accordingly, the location of the set of the objects is calculated to be on the right side of the direction of travel. On the other hand, when the car is at a point b in FIG. 13, the object h is outside the angle of view of the cropped image, so that the weighting for the objects e, f, and g is greater than the weighting of the object h. Accordingly, the location of the set of the objects is calculated to be on the left side of the direction of travel. During a travel from the point a to the point b, the location of the set of the objects changes from the right side to the left side of the direction of travel. Thus, the direction of view 705 of the car also changes from the right side to the left side of the direction of travel during a travel from the point a to the point b.

It should be noted that the degree of importance of each comment may be determined based on a degree of friendship between a user viewing the images and the writer of the comment. In this case, the friendship is obtained from the SNS such as FACEBOOK® and the degree of importance of the comment may be set to a higher value for a stronger friendship.

The image generation unit 105 generates the images to be presented to a user by obtaining the comment for each object from the object information DB 202, and superimposing the comment at the location of the object in the presentation frame.

In the above example, the direction of view is determined based on the coordinate of the centroid of the objects. However, when many comments are posted about one building (object), the direction of view may be determined based on the distribution range of the comments such that all of the comments about the building can be displayed. In other words, for example, all of the comments about the building may be displayed by determining the direction of view such that a comment that is in the furthest direction from the direction of travel is included in the angle of view.

In this case, for example, the location of the comment that is the furthest from the path may be determined as a representative location of the comments about the building. Alternatively, since some types of map information recently includes not only location information and name information of the building but also figure information of the building (area information), these pieces of information may be used to determine the direction of view so as to include the location that is the furthest from the path in a building area.

Furthermore, when many comments are posted about one building, besides the foregoing, a centroid position of the locations of the comments may be determined as the location of the building.

### Embodiment 3

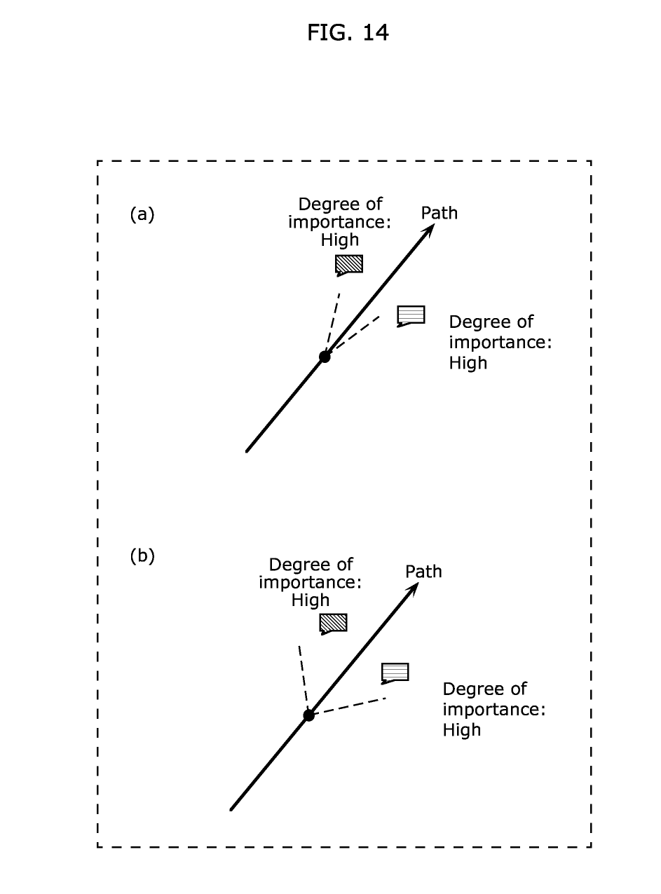

In the embodiment 1 and the embodiment 2, the cropped angle of view is constant during the cropping of images, but not limited to this. When a plurality of the objects exist and when the degrees of importance of the objects are almost the same and the distances between the respective objects and the car are also almost the same, each of the images may be cropped into a presentation frame so as to include the objects in the presentation frame, as shown in FIG. 14. More specifically, in such a case, the image cropping unit 104 may widen the cropped angle of view so as to include the objects in the presentation frame. FIG. 14 is a diagram for illustrating a change in the cropped angle of view. (a) in FIG. 14 illustrates a state in which the cropped angle of view has not been widened yet when distances between the respective objects and the car are the same, and (b) in FIG. 14 illustrates a state in which the cropped angle of view has been widened when the distances between the respective objects and the car are the same. In (a) and (b) in FIG. 14, the cropped angle of view and the direction of view are denoted by a dashed line.

However, the widened cropped angle of view causes wide-angle images, so that image distortion or a change in perspective occurs in the cropped images. Accordingly, a setting in which it is determined how much the cropped angle of view is allowed to be widened may be changed according to a user's viewing environment or the like in the following manner. For example, for a user viewing contents through a small tablet device or the like, when a slight image distortion or a slight change in perspective occurs due to a change in the cropped angle of view for presentation images, the user would have little feeling of strangeness. For this reason, the setting may be changed to allow the cropped angle of view to be widened. On the other hand, for a user viewing contents through an immersive image device (for example, a head mounted display) or the like, when a slight image distortion or a slight change in perspective occurs due to a change in the cropped angle of view for presentation images, the user would have a strong feeling of strangeness. For this reason, the setting may be changed to minimize a change in a field of view.

Furthermore, when the cropped angle of view is changed during the reproduction of the presentation images, some of users may have a feeling of strangeness due to the change in perspective. For this reason, when the field of view is changed, the upper limit of the change in angle between the image frames may be defined to prevent a sudden change in the field of view.

Using values such as the distances between the respective objects and the car, any one of the objects may be displayed prior to the others. After a user is informed that the others are outside the presentation frame, at least one of a process for changing the cropped angle of view and a process for changing the direction of view may be performed. In this case, an image may be cropped into not only a priority presentation frame which includes the object having priority, but also a non-priority presentation frame which includes the objects not included in the priority presentation frame. The non-priority presentation frame and the priority presentation frame may be reproduced separately, or they may be reproduced and displayed simultaneously in a split screen mode or the like.

The foregoing setting may be provided in advance as a default, or may be selected or appropriately changed by a user.

It should be noted that, in the embodiment 3, the cropped angle of view is changed during the cropping of images when the degrees of importance of the objects are almost the same and the distances between the respective objects and the car are also almost the same, but not limited to this. The image cropping unit 104 may crop an image into a cropped image (presentation frame) having a wider angle of view for a higher weighting factor given to the object, such as a degree of importance for the object.

### Embodiment 4

When images are reproduced, a digest viewing specialized for viewing an object is made possible by extracting and reproducing only image frames that includes the object instead of reproducing all image frames stored in the image information DB 204. In other words, the image cropping unit 104 further crops, into the cropped image, an image of the images which is at least during a time period when the object is included, and covers both the direction from the location of the moving object toward the location of the object and one of the direction of travel and the opposite direction.

More specifically, only frames determined to be YES in Step S230 of the direction-of-view determination process should be used to generate presentation images. In order to prevent the object from appearing suddenly, not only the frames determined to be YES in Step S230 but also several or several tens of frames following and preceding the frames may be extracted.

It should be noted that image frames to be processed for the digest viewing may be determined off-line in advance. The result of the determining may be whether or not each of the image frames is to be processed for the digest viewing, or may be information on a range of the image frames to be processed for the digest viewing (for example, a starting/ending frame number). The result of the determining also may be associated with the image frame, or may be stored separately if the result can be related to the image frame by referring to a frame number for example. The image cropping unit 104 may determine whether or not the object is included, based on the images before cropping or the presentation images after cropping.

The image cropping unit 104 also may determine, based on the objects, the image frames to be processed for the digest viewing. In this case, for each of the objects, the image frames in which the car comes close to the object are extracted in advance, and each of the extracted image frames should be checked in a similar manner to Step S230. Furthermore, when an additional object is provided as needed, the image cropping unit 104 can efficiently perform the process by extracting, in advance, the image frames in which the car comes close to the additional object, and determining the extracted image frames as the image frames to be processed for the digest viewing.

### Embodiment 5

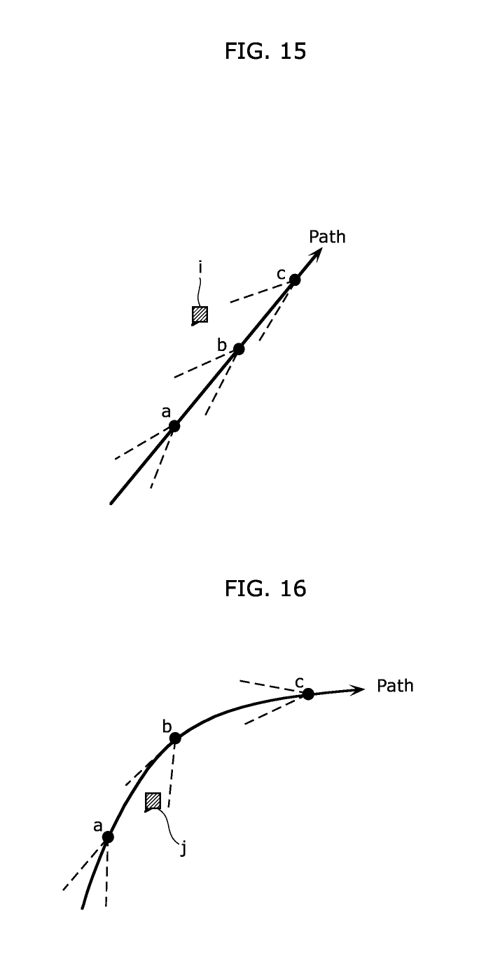

Images of a view stored in the image information DB 204 is not limited to images of a forward view. For example, images of a backward view are possible. In other words, a device for capturing images which makes up the image information generation unit 203 may be directed toward a direction of travel of the car or an opposite direction to the direction of travel of the car. In this case, for example, as shown in FIG. 15, when the images are cropped, the direction of view is shifted toward an object in advance after a point b at which the car comes close to the object i up to a predetermined distance. As described above, the images are cropped in a manner that shifts the direction of view toward the object in advance at the point b, so that the object can be included in a presentation frame at the next point c. Accordingly, presentation images can be generated so as to include the object as long as possible. Furthermore, as shown in FIG. 16, when a path of travel of the car is curved, the direction of view is shifted toward the object j. Accordingly, the presentation images can be generated so as to include the object as long as possible.

### Other Embodiments

In the foregoing embodiments, a set of images of a forward view stored in the image information DB 204 is a 360 degree panoramic video, but not limited to this. Any angle of view is possible as long as the panoramic video keeps a predetermined angle of view and is a set of images of a forward view which is captured at a wide angle (such as 180 degrees or 120 degrees) so as to allow the direction of view to be shifted to some extent. In addition, the set of images of a view is a video, but not limited to this. A set of still images captured at different times is possible. When the set of the images of a view is the set of still images, each of the still images is processed in the same manner as the image frame as described above.

The object information receiving unit 201 (i) regards a location designated on a map as a location of an object, (ii) receives a comment about the location or a comment about a building positioned at the location, (iii) pairs the designated location with the comment, and (iv) receives the pair as the object, but information on the object obtained by the object information obtaining unit 101 may be received from a server of the SNS.

The image generation device 100 can generate presentation images by performing the image generation process on a panoramic video stored in the image information DB 204. Accordingly, the image generation process may be performed in real time on a panoramic video generated by the image information generation unit 203, or may be performed on the panoramic video previously stored in the image information DB 204.

The image generation unit 105 generates images to be presented to a user by obtaining a comment for each of the objects from the object information DB 202, and superimposing the comment at the location of the object in the presentation frame, but the image generation unit 105 is not essential to the present disclosure. A captured panoramic video with position coordinates or a set of captured wide-angle images should be cropped so as to allow the object to appear in a field of view as long as possible. Accordingly, the presentation images may be generated so as to include the object as long as possible without presenting a comment corresponding to the object. Alternatively, the image generation unit may control whether or not the comment corresponding to the object is presented. Furthermore, the image generation unit may control whether the comment corresponding to the object or information corresponding to the object (see FIG. 3) is presented. The comment to be presented should be displayed at a time when the object appears in the presentation images. Accordingly, instead of being superimposed at the location of the object in the presentation frame, the comment may be displayed on another provided display frame separate from the presentation frame.

The image generation device according to the present disclosure can be implemented as a server device which provides, to a terminal device, images of a forward or backward view captured from the car. In addition, the image generation device according to the present disclosure also can be implemented as a system including the server device and the terminal device. In this case, for example, the terminal device may include the image cropping unit and the image generation unit, and the server device may provide, to the terminal device, information on an object and information on a path.

Although an image generation device and an image generation method according to one or more aspects of the present disclosure have been described in detail above, those skilled in the art will readily appreciate that various modifications may be made in these aspects without materially departing from the principles and spirit of the inventive concept, the scope of which is defined in the appended Claims and their equivalents.

### INDUSTRIAL APPLICABILITY

As described above, according to the present disclosure, an image generation device can be provided which is capable of displaying information on an object during a certain amount of time for images of a forward view captured from a moving object even when the object is located at a position away from a direction of travel of the moving object. Accordingly, the image generation device is useful as a server device which provides, to a terminal device, the images of the forward view captured from the moving object.

Furthermore, the image generation device according to the present disclosure can be implemented as a system including the server device and the terminal device.

1. An image generation device comprising:
an object information obtaining unit configured to obtain a location of an object;
an image information obtaining unit configured to obtain images captured from a moving object and locations of the moving object of a time when the respective images are captured;
a traveling direction obtaining unit configured to obtain directions of travel of the moving object of the time when the respective images are captured; and
an image cropping unit configured to (i) calculate a direction of view covering both a direction from a location of the moving object toward the location of the object and one of a direction of travel of the moving object and an opposite direction to the direction of travel, and (ii) crop an image into a cropped image based on the calculated direction of view, the image being one of the images, the cropped image being a portion of an angle of view of the image, the location of the moving object being of a time when the image is captured, the direction of travel of the moving object being of the time when the image is captured.

2. The image generation device according to claim 1,
wherein the image cropping unit is configured to, for each of all or some of the images, (i) calculate the direction of view of the time when the image is captured and (ii) crop the image into the cropped image based on the calculated direction of view.

3. The image generation device according to claim 1, further comprising
an image generation unit configured to generate images in each of which information on the object is associated with the object in the cropped image,
wherein the object information obtaining unit is further configured to obtain the information on the object.

4. The image generation device according to claim 1,
wherein the image cropping unit is configured to determine the direction of view based on a weighting factor given to the direction from the location of the moving object toward the location of the object and a weighting factor given to one of the direction of travel and the opposite direction.

5. The image generation device according to claim 1,
wherein the image cropping unit is configured to crop the image into the cropped image so that one of (i) the direction from the location of the moving object toward the location of the object and (ii) one of the direction of travel and the opposite direction is positioned within a predetermined range of an angle between directions corresponding to both ends of the cropped image.

6. The image generation device according to claim 1,
wherein the traveling direction obtaining unit is configured to derive and obtain, from two or more locations where the respective images are captured, the directions of travel of the moving object each related to a corresponding one of the locations where the respective images are captured.

7. The image generation device according to claim 1,
wherein the image cropping unit is configured to crop the image into the cropped image having a wider angle of view for a higher weighting factor given to the object.

8. The image generation device according to claim 1,
wherein, when a plurality of the objects exist, the image cropping unit is configured to determine the direction of view based on weighting factors given to the respective objects.

9. The image generation device according to claim 1,
wherein, when a plurality of the objects exist, the image cropping unit is configured to crop the image into the cropped image having a widened angle of view that allows the objects to be included in the cropped image.

10. The image generation device according to claim 1,
wherein the image cropping unit is further configured to crop, into the cropped image, an image of the images which is at least during a time period when the object is included, and covers both the direction from the location of the moving object toward the location of the object and one of the direction of travel and the opposite direction.

11. An image generation method comprising:
obtaining a location of an object;
obtaining images captured from a moving object and locations of the moving object of a time when the respective images are captured;
obtaining directions of travel of the moving object of the time when the respective images are captured; and
calculating a direction of view covering both a direction from a location of the moving object toward the location of the object and one of a direction of travel of the moving object and an opposite direction to the direction of travel, and cropping an image into a cropped image based on the calculated direction of view, the image being one of the images, the cropped image being a portion of an angle of view of the image, the location of the moving object being of a time when the image is captured, the direction of travel of the moving object being of the time when the image is captured.
